(19) United States
(12) Patent Application Publication
(10) Pub. No.: US 2026/0225842 A1
(43) Pub. Date: Aug. 6, 2026

(54) SHAFT FOR WINDING ON A PORTION OF A LABEL TAPE

(71) Applicant: KRONES AG, Neutraubling (DE)

(72) Inventors: Luis FUHRMANN, Waldsassen (DE); Martin WAGNER, Regensburg (DE)

(21) Appl. No.: 19/421,622

(22) Filed: Dec. 16, 2025

(30) Foreign Application Priority Data
Jan. 31, 2025 (DE) 10 2025 103 655.1

(51) Int. Cl. B65H 19/18; B65C 9/18

(52) U.S. Cl. CPC B65H 19/18; B65C 9/1892; B65H 2301/46115; B65H 2406/34; B65H 2701/192

(57) ABSTRACT

The invention relates, inter alia, to a shaft for winding on a portion of a label tape from a label roll for a handling apparatus for handling the label tape of the label roll. The shaft has a shaft main body with a longitudinal gap, preferably a longitudinal suction and/or longitudinal clamping gap, for receiving and holding a beginning of the portion of the label tape.

### TECHNICAL FIELD

The invention relates to a shaft for winding on a portion of a label tape from a label roll for a handling apparatus for handling the label tape. The invention further relates to a handling apparatus, to a method for handling a label tape of a label tape roll, to a method for manufacturing a shaft, and to a computer program product.

### TECHNICAL BACKGROUND

A container treatment plant can comprise a labeling device for labeling containers. For example, the labeling device can label the containers with labels from a label roll (roll of label material).

Traditionally, the label rolls are refilled manually by an operator. The user may have to perform additional tasks, such as cutting the label tape to the correct position, applying double-sided adhesive tape to the label tape, or inserting the label tape into an automatic gluing. It is also possible to use roll magazines, which can be manually loaded with multiple rolls.

DE 10 2021 125 133 A1 describes a mobile robot, a supply system, and a method for changing label rolls on a labeling unit for labeling containers. The mobile robot accordingly comprises a vehicle unit for changing locations of the robot and a manipulator unit with a multi-axle manipulator and an associated end effector for manipulating label rolls. Since the end effector is designed to grip the outer circumference of the label rolls and emptied roll cores of label rolls so as to carry them, ergonomically problematic work steps when refilling label rolls can be accomplished exclusively by machine with a high degree of precision and in a material-saving manner.

EP 3 760 550 A1 describes a transfer unit for feeding rolls of labeling material to a labeling module that is configured to apply labels to objects. The transfer unit includes a support element configured to support a plurality of rolls arranged vertically in at least one stack. The transfer unit further has a robot arm configured such that it removes at least one roll from the stack at a gripping station and releases it at a release station.

The invention is based on the object of creating an improved technology for handling label tapes for loading a labeling system.

### SUMMARY OF THE INVENTION

The object is achieved by the features of the independent claims. Advantageous developments are specified in the dependent claims and the description.

One aspect concerns a shaft, preferably a suction and/or clamping shaft, for winding on a portion of a label tape from a label roll for a handling apparatus for handling the label tape. The shaft has an (e.g. one-piece or multi-piece) shaft main body with an (e.g. variable) longitudinal gap, preferably a longitudinal suction and/or longitudinal clamping gap, for receiving and holding a beginning of the portion of the label tape.

Advantageously, a compact and universally usable shaft for label tape handling can be provided in this way. The fact that the label tape can be securely fastened by being received in the longitudinal gap and wound onto the shaft advantageously results in a high degree of process reliability. This advantage can be further supported by the fact that the label tape can only be cut at the very end during handling, e.g. when being transferred to a gluing device, e.g. splicing station. A tape force control system can advantageously make a taut yet gentle label tape transportation possible. The tape force control can be achieved, for example, by the shaft and/or by a label roll holder (e.g. film plate), e.g. depending on a signal output from a force sensor. In combination with a roller gripper, the handling via the shaft can advantageously provide a fully automated solution for the supply of consumables.

In one exemplary embodiment, the shaft main body is formed (e.g. completely or partially) from a plurality of adjacent, preferably additively manufactured material layers (e.g. PA material layers).

Advantageously, the shaft main body (and possibly the entire shaft) can be manufactured very cost-effectively and quickly (Rapid Manufacturing) by additive manufacturing and the associated geometric freedom and functional integration. Advantageously, so-called print-in-place in additive manufacturing allows additional functions to be integrated directly into the shaft main body, e.g. a suction functionality, a clamping functionality and/or a line functionality. This can also be advantageous in saving assembly time and additional costs for additional components. Additive manufacturing can advantageously make possible a very lightweight variant construction, e.g. with different shaft lengths. By using lightweight construction principles, a minimization of material usage can be advantageously achieved. Advantageously, the shaft can theoretically be designed for fatigue strength and can be maintenance-free.

In a further exemplary embodiment, at least one of the following conditions is met:
the shaft main body has a substantially cylindrical outer shape;
the longitudinal gap opens in an outer circumferential face of the shaft main body;
the shaft is a hollow shaft;
the outer circumferential face of the shaft has a non-stick coating (e.g. made of silicone or PTFE);
the shaft has at its free end a shoulder, preferably partially or completely circumferential, (e.g. of the shaft main body or of a jacket) in order to prevent the label tape from slipping off the shaft;
the longitudinal gap extends essentially along an entire length of the shaft main body;
the shaft and/or the shaft main body has a total length≥200 mm and/or ≤300 mm; and
the shaft and/or the shaft main body has an outer diameter≥50 mm and/or ≤100 mm.

In one embodiment, the shaft further comprises a preferably sleeve-shaped (tubular) and/or metallic (e.g. aluminum) jacket that surrounds the shaft main body, preferably detachably (e.g. the shaft main body can be detachably inserted into the jacket). Optionally, the jacket can have a non-stick coating on its outer circumferential face. Preferably, one or both end regions of the shaft main body can have tolerance compensation elements, preferably projecting or nose-shaped or arcuate. The tolerance compensation elements can be arranged distributed around an outer circumference of the shaft body, and/or can hold the shaft body in the jacket in a form-fitting and optionally a force-fitting manner.

Advantageously, the jacket can be machined with high precision, and the shaft main body, which is e.g. additively manufactured, can be inserted into the jacket. This can have the advantage that the jacket is relatively dimensionally stable and that higher accuracy can be achieved for further assembly, e.g. on a gripper. Furthermore, delicate plastic elements of the shaft main body can be advantageously protected from contamination and, in the event of a collision, from damage. Further advantages of the jacket can be found, for example, with regard to various safety aspects. For example, regions of the shaft body exposed to pressure or vacuum can be shielded from the environment, eliminating any danger in the event of damage. The risk of jamming due to a clamping functionality of the shaft main body can also be minimized by the jacket.

Advantageously, the tolerance compensation elements can compensate for manufacturing process-related tolerances of the shaft main body at the joining diameters of the shaft main body to the jacket. This advantageously ensures assembly capability even without further post-processing machining steps.

For example, the jacket can have a longitudinal gap that covers the longitudinal gap of the shaft main body.

Preferably, the jacket can be formed as a hollow shaft.

Alternatively, it is also possible, for example, for the shaft main body itself to form an outer circumferential face of the shaft for contacting the portion of the label tape when the portion is wound on. In other words, the shaft does not have a separate jacket in which the shaft main body is positioned.

In another embodiment, the shaft main body has a suction device for sucking the beginning of the portion of the label tape into the longitudinal gap. This can advantageously support the reception of the beginning of the label tape in the longitudinal gap.

In one embodiment variant, at least one of the following conditions is met:
the suction device is arranged in the shaft;
the suction device has a suction nozzle which is connected to the longitudinal gap for sucking in the beginning of the portion of the label tape;
the suction device is formed (e.g. completely) from a plurality of adjacent, preferably additively manufactured material layers (e.g. PA material layers);
the suction device extends essentially along the entire length of the shaft main body; and
the suction device has a vacuum line which is connected (e.g. to the suction nozzle (e.g. integrally in one piece)) and is arranged parallel to and spaced apart from a central longitudinal axis of the shaft.

In another embodiment variant, the shaft main body has a clamping device, preferably pneumatic, which is arranged to clamp the beginning of the portion of the label tape in the longitudinal gap. This method advantageously supports holding the beginning of the label tape in the longitudinal gap and securely winding the portion of the label tape onto the shaft.

In one exemplary embodiment, at least one of the following is fulfilled:
the clamping device is arranged in the shaft;
the clamping device is formed (e.g. completely) from a plurality of adjacent, preferably additively manufactured material layers (e.g. PA material layers);
the clamping device comprises a clamping element (e.g. plate-shaped), preferably elastically pre-tensioned (e.g. for clamping), which is movable for clamping and releasing the beginning of the label tape portion (e.g. relative to a counterholder), wherein the clamping element is preferably aligned with the longitudinal gap of the shaft main body and/or extends essentially along the entire length of the longitudinal gap; and
the shaft main body has an (e.g. plate-shaped) counterholder or a counterholder of the shaft is detachably positioned in the shaft main body (e.g. inserted), preferably via a dovetail guide and/or a latching connection, wherein the counterholder is arranged to clamp the beginning of the portion of the label tape between itself and the clamping device.

In another embodiment, the clamping device has at least one, preferably pneumatic, clamping actuator, preferably a bellows, for moving a clamping element of the clamping device. Optionally, in addition at least one of the following is met:
the at least one clamping actuator is formed (e.g. completely) from a plurality of adjacent, preferably additively manufactured material layers (e.g. PA material layers); and
the shaft main body has a compressed air line which is connected to the at least one clamping actuator (e.g. integrally in one piece) and is preferably arranged parallel to a central longitudinal axis of the shaft.

In one embodiment, the shaft further comprises a tape sensor arranged to detect the beginning of the label tape portion received in the longitudinal gap. This can be used, for example, to check whether the beginning of the label tape has been successfully received in the longitudinal gap.

In a further embodiment, at least one of the following conditions is met:
the tape sensor is arranged in the shaft main body, preferably to detect the beginning of the portion of the label tape projecting into the shaft main body through the longitudinal gap;
the tape sensor is an optical sensor, preferably a laser sensor or an LED sensor;
the tape sensor is connected to the shaft main body in a rotationally fixed manner;
the tape sensor is arranged in or on a free end region of the shaft; and
the shaft main body has a plurality of holding elements in its interior along its length which hold a signal line that is connected to the tape sensor.

Another aspect concerns an (e.g. stationary) handling apparatus, preferably a robotic handling apparatus (e.g. articulated-arm robotic handling apparatus), for handling a label tape of a label roll. The handling apparatus has a shaft as disclosed herein. Preferably, at least one of the following conditions can also be met:
the shaft is an end effector of the handling apparatus;
the shaft is rotatably mounted only at one end of the shaft; and
at least one of a rotary distributor (e.g. for compressed air or vacuum), a mounting flange and a vacuum generator is formed from a plurality of adjacent, preferably additively manufactured material layers, preferably together with the shaft main body.

A further aspect relates to a labeling system for labeling containers. The labeling system comprises two label roll holders for in each case holding a label roll, a gluing device (e.g. a splicing device) for connecting a beginning of a label tape from one of the label rolls to an end of a label tape from the other label roll, and a handling apparatus as disclosed herein. The handling apparatus is configured (e.g. by a processing device) to feed a portion of a label tape from a label roll selectively from one of the two label roll holders to the gluing device via the shaft, and optionally to prepare the portion for the gluing device, preferably to cut it to size and/or to provide it with an adhesive (e.g. double-sided adhesive tape).

A further aspect relates to a container processing line (e.g. for controlling temperature, producing, cleaning, coating, testing, filling, closing, pasteurizing, decorating, labeling, printing, marking, laser marking, and/or packaging containers for liquid or pasty media, preferably beverages, liquid foods, or products from the pharmaceutical or healthcare industry). The container treatment system can include the shaft as disclosed herein, the handling apparatus as disclosed herein, or the labeling system as disclosed herein. The container treatment system can, for example, be a beverage filling plant.

Another aspect concerns a method for handling a label tape of a label roll by means of a shaft as disclosed herein or by means of a handling apparatus as disclosed herein. The method comprises: picking up the beginning of a portion of a label tape from a label roll (e.g. from a label roll holder (e.g. turntable) of a labeling system) in the longitudinal gap of the shaft main body, preferably supported by a suction of the beginning by a suction device of the shaft.

Optionally, the method further comprises at least one of:
detecting the beginning received in the longitudinal gap by means of a tape sensor of the shaft;
holding the beginning received in the longitudinal gap in the longitudinal gap by means of a clamping device of the shaft;
winding the portion onto the shaft by rotating the shaft (e.g. by means of a handling apparatus); and
moving the portion by moving the shaft in space, e.g. by means of a handling apparatus (e.g. handling robot).

A further aspect relates to a method for manufacturing a shaft as disclosed herein. The method comprises: additive manufacturing of the shaft main body in a plurality of adjacent material layers, preferably in a powder bed method (e.g. MJF: Multi-Jet Fusion) or a PolyJet method (e.g. PolyJet modeling).

For example, the PolyJet method can be advantageous in making it possible for different functional regions of the shaft main body to be additively manufactured from different materials within a single manufacturing process. For example, this would allow the clamping actuators to be manufactured from a material optimized for reversible deformation. For the surface of the counterholder, for example, a material with rubber-like properties could be used to achieve not only deformation suitability but also a high coefficient of friction. In regions within the shaft main body where the force flow resulting from the clamping prevails (e.g. at the counterholder), reinforced materials could be used in addition to geometric reinforcement.

It is possible for the method also to comprise chemical smoothing of surfaces of the shaft main body. Advantageously, this can improve the surface quality of the shaft. This can for example have a positive effect on the service life of clamping actuators formed as bellows. The notch effect in tight radii of the folds can be advantageously reduced.

Another aspect relates to a computer program product having (e.g. at least one computer-readable storage medium with instructions stored thereon) instructions that cause an additive manufacturing device (e.g. 3D printer) to carry out a method of manufacturing a shaft as disclosed herein, or to manufacture a shaft as disclosed herein in a plurality of adjoining material layers in an additive manufacturing method.

For example, the computer program product can comprise a data file with a representation of the shaft and/or of the shaft main body. For example, the representation can be a 3D model of the shaft and/or of the shaft main body. For example, the representation can have multiple layers, which can represent, for example, the multiple material layers.

The preferred embodiments and features of the invention described above can be combined with one another as desired.

### BRIEF DESCRIPTION OF THE FIGURES

Further details and advantages of the invention are described below with reference to the accompanying drawings. In the figures:

FIG. 1 shows a schematic perspective view of a label roll;

FIG. 2 shows a perspective view of a shaft according to an exemplary embodiment;

FIG. 3 shows a perspective view of a shaft main body of the exemplary shaft;

FIG. 4 shows another perspective view of the shaft main body;

FIG. 5 shows a perspective sectional view through the exemplary shaft;

FIG. 6 shows a further sectional view through the exemplary shaft;

FIG. 7 shows a sectional view through the shaft main body;

FIG. 8 shows a perspective view of a portion of a labeling system and a handling apparatus according to an exemplary embodiment;

FIG. 9 shows a perspective sectional view through the shaft main body when the beginning of a label tape on a label roll is being picked up;

FIG. 10 shows a perspective view of a region of a shaft main body;

FIG. 11 shows a perspective view of a shaft according to a further exemplary embodiment;

FIG. 12 shows a perspective view of a shaft according to a further exemplary embodiment;

FIG. 13 shows a perspective view of a shaft according to a further exemplary embodiment;

FIGS. 14-17 show schematic representations of shaft regions to illustrate an elastic pre-tensioning of a clamping functionality of the relevant shaft.

The embodiments shown in the drawings correspond at least in part, so that similar or identical parts are provided with the same reference signs and reference is also made to the description of other embodiments or figures for the explanation thereof to avoid repetition.

### DETAILED DESCRIPTION OF EMBODIMENTS

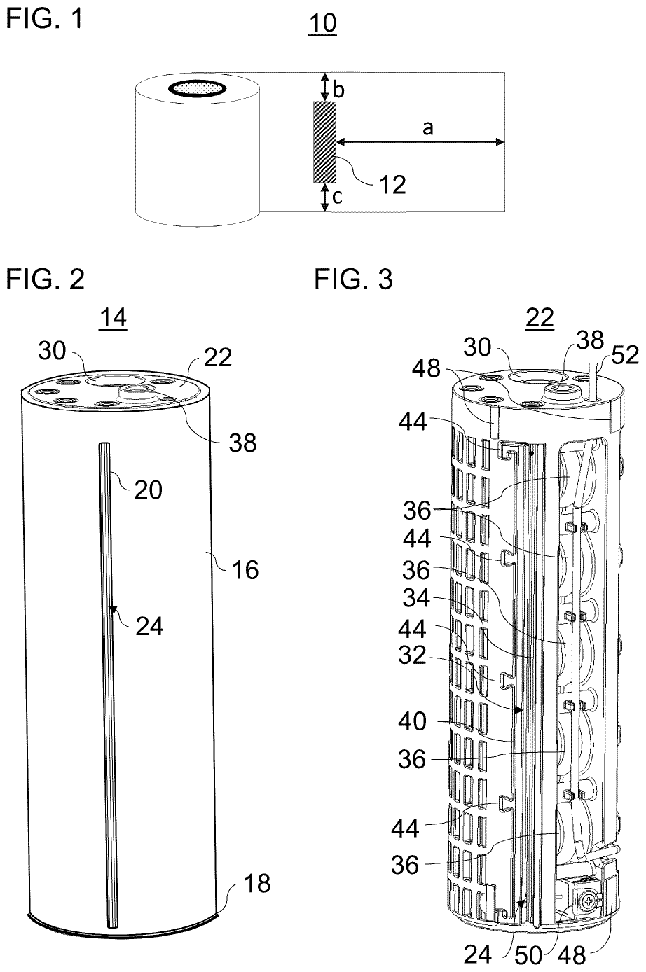

FIG. 1 shows a preferred embodiment of a label roll 10 which has been prepared for handling by means of a shaft disclosed herein. FIG. 1 shows a state during the preparation before the gluing of the label roll 10.

The label roll 10 or its label tape can, for example, have a height in a range between 20 mm and 200 mm, although other tape heights are also conceivable. The label tape material can preferably be polypropylene (PP), although other tape materials are also conceivable.

Preferably, an (initial) portion of the label tape of the label roll 10 can be secured (e.g. at the manufacturer) by a double-sided adhesive tape 12, such that the initial portion projects beyond this adhesive tape 12 by a distance a. The adhesive tape 12 can therefore be arranged at a distance a from a starting edge of the label tape. The distance a can be for example a few centimeters, e.g. between 30 mm and 40 mm.

Preferably, the adhesive tape 12 can also be arranged at a distance from a top edge and/or a bottom edge of the label tape. For example, the distance b to the top edge can be between 1 mm and 5 mm. The distance c to the bottom edge can be between 1 mm and 5 mm.

Preferably, the adhesive tape 12 can have two sides with different adhesive strengths. This could for example ensure that the adhesive tape 12 remains on the desired side when the tape start is pulled off, e.g. at the tape start and not on the label roll 10.

Another conceivable way of preparing the beginning of the tape would be, for example, an adhesive strip with a non-adhesive end that can be picked up by the shaft disclosed herein.

FIGS. 2 to 7 show different views and portions of a shaft 14 for handling a label tape of a label roll 10, as shown by way of example in FIG. 1.

The shaft 14 is used to pick up and wind on an (initial) portion of the label tape from the label roll 10. To receive the beginning of the label tape, the shaft 14 can be a hollow shaft. The label tape can be held on the portion wound on the shaft 14 by means of the shaft 14. The label tape held in this way can then be handled further and treated, for example.

Preferably, the shaft 14 can be part of a handling apparatus for handling the label tape. For example, the shaft 14 can be formed as an end effector or part of an end effector for attachment to a robot arm of a robot, preferably a multi-axis robot, e.g. an articulated-arm robot. For example, it is possible for the robot to pick up the shaft 14 at a tool-changing station, preferably automatically. For example, the robot could change the shaft 14 and a label roll gripper for gripping and handling entire label rolls 10 at the tool-changing station as needed. It is possible for the shaft 14 to be used in other applications.

As explained in detail below by way of example, shaft 14 can also be referred to as a suction and/or clamping shaft, depending on the embodiment.

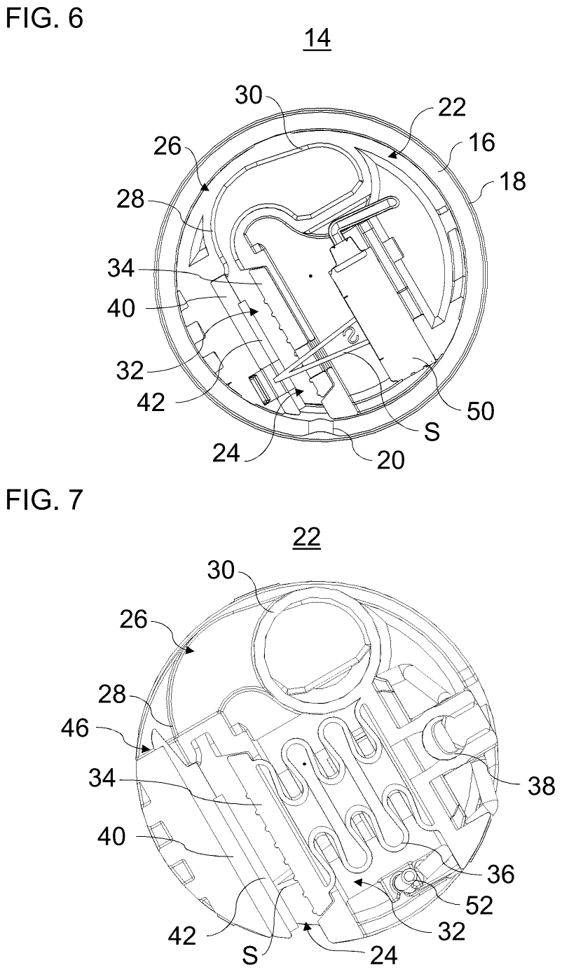

The shaft 14 has a shaft main body 22. Optionally, the shaft 14 can, for example, also have a jacket 16 (shown only in FIGS. 2, 5 and 6) and/or a tape sensor 50 (visible only in FIGS. 3 and 6).

The shaft 14 can preferably have an outer diameter≥50 mm and/or ≤100 mm, e.g. approx. 80 mm or less. For example, the jacket 16 and/or the shaft body 22 can have an outer diameter≥50 mm and/or ≤100 mm, e.g. approx. 80 mm or less.

Advantageously, such a small outer diameter allows a low moment of inertia to be achieved, which in turn can be advantageous for controlling the tape force. Normally, with such an outer diameter, approximately eight revolutions of the shaft 14 are required (600 mm roll outer diameter/80 mm shaft diameter=7.5 shaft revolutions) to wind a first layer of the label roll 10 onto the shaft 14. Multiple/multi-layer wrapping of the shaft 14 can advantageously support a secure fastening of the label tape on the shaft 14.

The shaft 14 can preferably have a total length≥200 mm and/or ≤300 mm. For example, the jacket 16 and/or the shaft main body 22 can have a total length≥200 mm and/or ≤300 mm. Preferably, with such a total length, a large number of label tapes of different heights can be handled by the shaft 14.

The jacket 16 is preferably sleeve-shaped/tubular. Preferably, the jacket 16 can be realized as a sleeve. The jacket 16 can surround the shaft main body 22, preferably detachably. The shaft main body 22 can be arranged in the jacket 16. Preferably, the shaft main body 22 can be inserted into the jacket 16. For example, the jacket 16 can be a metallic jacket, for example an aluminum jacket.

An outer circumferential face of the jacket 16 can contact the label tape, and the label tape can be rolled onto these outer circumferential faces if desired. Preferably, the outer circumferential face of the jacket 16 can have a non-stick coating. This can advantageously avoid adhesion with adhesive tape for tape fastening or its adhesive residue. The non-stick coating can be, for example, a ceramic or plastic coating. For example, the non-stick coating can be made of silicone or PTFE.

The shaft 14 can have a shoulder 18. For example, the jacket 16 or the shaft main body 22 can have the shoulder 18. The shoulder 18 can be for example shaped like a circumferential bead or a collar.

The shoulder 18 can preferably be arranged at a free (lower) end of the shaft 14. The shoulder 18 can be completely or partially circumferential around the shaft 14. The shoulder 18 prevents the label tape from running off or slipping off the shaft 14. One, e.g. lower, longitudinal edge of the label tape can be supported on the shoulder 18. The label tape can, for example, be guided along the shoulder 18 when being wound onto the shaft 14.

The jacket 16 can have a longitudinal gap 20. The longitudinal gap 20 can extend parallel to a longitudinal axis of the jacket 16. The longitudinal gap 20 can connect an outer circumferential face of the jacket 16 with an inner circumferential face of the jacket 16. Through the longitudinal gap 20, a beginning of the label tape can pass through the jacket 16 and be inserted into the shaft 14 and thus into the shaft main body 22.

Alternatively, it is possible for example for the shaft 14 not to have a jacket. For example, the shaft main body 22 itself can form an outer circumferential face of the shaft 14 for contacting and winding on the portion of the label tape.

Preferably, the shaft main body 22 can be formed completely or partially from a plurality of adjacent, additively manufactured material layers. The material layers can be, for example, polyamide material layers (PA material layers), such as PA12. For example, the shaft main body 22 can be additively manufactured using a powder bed method (e.g. MJF: Multi-Jet Fusion) or a PolyJet method (e.g. PolyJet modeling). If the additive manufacturing is carried out using a powder bed method, preferably all regions of the shaft main body 22 can be formed in such a way that the unmelted residual powder can be removed from the shaft main body 22. For example, the shaft main body 22 can have a plurality of depowdering openings for this purpose.

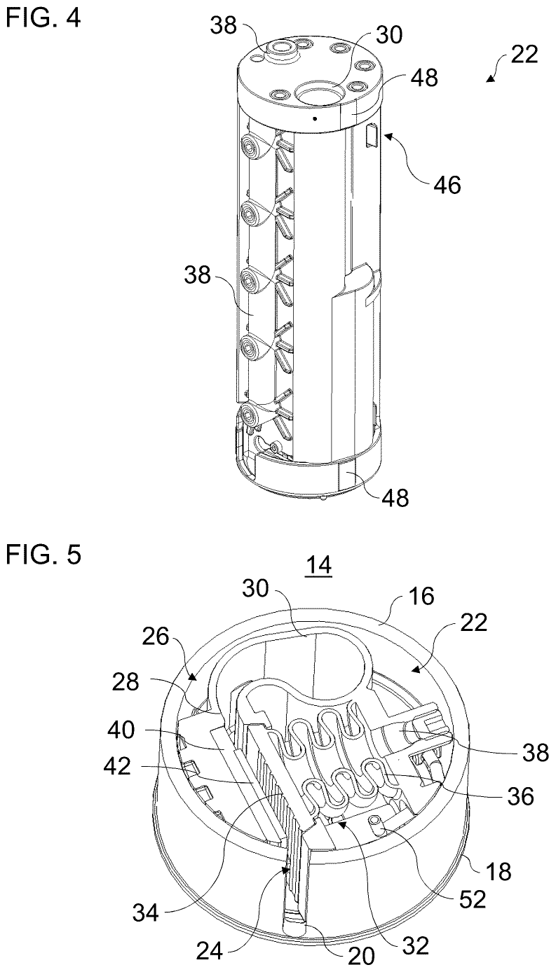

Following the principle of lightweight construction, wall thicknesses and cross-sections of different regions within the shaft main body 22 can be reinforced according to the respective force application (see, for example, profiled and/or perforated and/or ribbed regions of the shaft main body 22 in FIGS. 3 and 4).

The shaft main body 22 can have an essentially cylindrical outer shape.

The shaft main body 22 has a longitudinal gap 24. The longitudinal gap 24 can receive the beginning of the portion of the label tape.

Preferably, the beginning can be held in the longitudinal gap 24 in any conceivable way, e.g. by clamping and/or suction. For example, the longitudinal gap 24 can be formed as a longitudinal suction gap and/or longitudinal clamping gap.

The longitudinal gap 24 can preferably extend parallel to a longitudinal axis of the shaft 14. Preferably, the longitudinal gap 24 can extend essentially along the entire length of the shaft main body 22. The longitudinal gap 24 can, for example, have a total length≥200 mm and/or ≤300 mm.

If the jacket 16 is included, the longitudinal gap 20 of the jacket 16 and the longitudinal gap 24 of the shaft main body 22 can be aligned with each other, preferably flush. For example, the longitudinal gap 20 of the jacket 16 can overlap/cover the longitudinal gap 24 of the shaft main body 22.

Preferably, the shaft main body 22 can have a suction device 26 and/or a clamping device 32 and/or at least one tolerance compensation element 48.

The suction device 26 can be formed and arranged to suck the beginning of the label tape toward and into the longitudinal gap 24 of the shaft main body 22.

The suction device 26 is preferably arranged in the (hollow) shaft 14. The suction device 26 can be connected to the shaft 14 in a rotationally fixed manner and rotate with the shaft 14.

For example, the suction device 26 can have at least one suction nozzle 28. The suction nozzle 28 can be arranged in the shaft 14. The suction nozzle 28 can for example extend essentially along the entire length of the shaft 14 and/or the shaft main body 22. Preferably, the geometry of the suction nozzle 28 can be designed to optimize flow.

By means of the suction nozzle 28, the beginning of a label tape can be sucked into the longitudinal gap 24 (and possibly into the longitudinal gap 20). The suction nozzle 28 can preferably be connected to the longitudinal gap 24 and, if applicable, 20. In other words, the longitudinal gap 24 can be an inlet opening to the suction nozzle 28, through which a beginning of the label tape can be sucked into the suction nozzle 28.

It is possible for the suction device 26 to have a vacuum line (line to which a vacuum is applied) 30. The vacuum line 30 can for example have a tubular shape. A longitudinal axis of the vacuum line 30 can preferably run parallel and spaced apart from a central longitudinal axis of the shaft 14. Preferably, the course of the vacuum line 30 can be designed to optimize the flow.

The vacuum line 30 can at one end be connected to the suction nozzle 28 for sucking in air. The suction nozzle 28 can for example extend radially from the vacuum line 30 and lead to the longitudinal gap 24.

At the other end, the vacuum line 30 can be connected to a vacuum supply/vacuum source, e.g. outside the shaft 14. One end of the vacuum line 30 can open into an end face of the shaft main body 22. The vacuum source can, for example, include a vacuum generator, such as a side channel blower.

Preferably, the suction device 26 is formed completely or partially from a plurality of adjacent, additively manufactured material layers. The material layers can be, for example, polyamide material layers (PA material layers), such as PA12. For example, the suction device 26 can be additively manufactured using a powder bed method (e.g. MJF: Multi-Jet Fusion) or a PolyJet method (e.g. PolyJet modeling).

It is possible that the suction device 26 can be supported, for example, by at least one compressed air nozzle on the shaft 14 (not shown in the figures). For example, at least one compressed air nozzle can be arranged on the outside of shaft 14. For example, at least one compressed air nozzle can direct compressed air specifically onto the label roll 10 in order to lift the excess tape from the label roll 10 in order to receive it as the beginning of the label tape in the longitudinal gap 24.

The clamping device 32 can be provided for clamping the beginning of the label tape received in the longitudinal gap 24 and, if applicable, 20. Preferably, the clamping device 32 can clamp a beginning of the label tape that has been sucked into the shaft main body 22 through the longitudinal gap 24 and, if applicable, 20, by the suction device 26. Preferably, the clamping device 32 is a pneumatic clamping device.

The clamping device 32 is preferably arranged in the (hollow) shaft 14. The clamping device 32 can be connected to the shaft 14 in a rotationally fixed manner and rotate with the shaft 14.

Preferably, the clamping device 32 can extend essentially along an entire length of the shaft 14.

Preferably, the clamping device 32 is formed completely or partially from a plurality of adjacent, additively manufactured material layers. The material layers can be, for example, polyamide material layers (PA material layers), such as PA12. For example, the clamping device 32 can be additively manufactured using a powder bed method (e.g. MJF: Multi-Jet Fusion) or a PolyJet method (e.g. PolyJet modeling).

The clamping device 32 can have, for example, a clamping element 34 and at least one clamping actuator 36.

The clamping element 34 can be movable in order to clamp and release the beginning of the label tape. Preferably, the clamping element 34 is plate-shaped. Preferably, the clamping element 34 is aligned with the longitudinal gap 24. The clamping element 34 can extend essentially along the entire length of the longitudinal gap 24.

The at least one clamping actuator 36 can be connected to the clamping element 34 in order to move the clamping element 34.

Preferably, a plurality of clamping actuators 36 are comprised. For example, the multiple clamping actuators 36 can be arranged one above the other. With respect to a longitudinal axis of the shaft 14/the shaft main body 22, the plurality of clamping actuators 36 can preferably be arranged in a row next to each other/one above the other.

The at least one clamping actuator 36 can be, for example, an inflatable bellows or a pneumatic cylinder. The at least one clamping actuator 36, to which compressed air is applied, can press the clamping element 34 onto a counterholder 40 in order to clamp the beginning of the label tape or, alternatively or additionally, in order to move it away from the counterholder 40 to release the clamping.

For example, compressed air can be supplied to the at least one clamping actuator 36 via a compressed air line 38 of the clamping device 32. The compressed air line 38 can be connected to a compressed air supply, e.g. at an end face of the shaft 14.

The compressed air line 38 is preferably integrated directly into the shaft main body 22. Preferably, a longitudinal axis of the compressed air line 38 can be parallel to and spaced apart from a central longitudinal axis of the shaft main body 22. Preferably, the compressed air line 38 can have a flow-optimized course.

The beginning of the label tape can be clamped between the clamping element 34 and a counterholder 40. The clamping element 34 and the counterholder 40 can be positioned directly opposite one another. The counterholder 40 is preferably plate-shaped.

Preferably, the longitudinal gap 24 can be formed at least in portions between the clamping element 34 and the counterholder 40. A space between the clamping element 34 and the counterholder 40 can preferably form a portion of the suction nozzle 28.

The counterholder 40 can carry a non-slip element 42. The non-slip element 42 can be, for example, a rubber element, e.g. an EPDM element (ethylene propylene diene monomer rubber). The non-slip element 42 can be provided to increase the coefficient of friction. When clamping, the non-slip element 42 can rest against the beginning of the label tape and increase frictional resistance to the label tape.

It is possible for the non-slip element 42 to be carried on the clamping element 34.

It is also possible for the counterholder 40, e.g. as an alternative to carrying the non-slip element 42, to have a flexible and/or rough structuring (e.g. with an arc structure) to increase the coefficient of friction.

Preferably, the counterholder 40 is formed completely or partially from a plurality of adjacent, additively manufactured material layers. The material layers can be, for example, polyamide material layers (PA material layers), such as PA12. For example, the counterholder 40 can be additively manufactured using a powder bed method (e.g. MJF
Multi-Jet Fusion) or a PolyJet method (e.g. PolyJet Modeling).

The counterholder 40 can, for example, be inserted into the shaft main body 22 so as to be detachable (without tools). Preferably, the counterholder 40 can be detached from the shaft main body 22 and removed from the shaft main body 22 without the use of tools. The removability makes the counterholder 40 easy to clean and, if necessary, to replace with a new counterholder. For example, the entire shaft main body 22 thus does not need to be remanufactured.

For example, the counterholder 40 can be inserted into the shaft main body 22 via a dovetail guide 44 (see FIG. 3).

For example, the counterholder 40 can be detachably mounted on the shaft main body 22 via at least one latching connection 46 (see e.g. FIGS. 4 and 7). Preferably, the counterholder 40 can have a plurality of locking elements that can engage in or on support portions of the shaft main body 22.

Alternatively, it is possible, for example, for the counterholder 40 to be integrally connected to the shaft main body 22 in one piece or itself to be part of the shaft main body 22.

It is possible for the clamping element 34 to be elastically pre-tensioned towards the counterholder 40, e.g. in a springy manner. It is possible for the counterholder 40 to be elastically, e.g. in a springy manner, pre-tensioned towards the clamping element 34.

Preferably, the clamping element 34 and/or the counterholder 40 can be at least partially profiled and/or elastically compressible. For example, a surface of the clamping element 34 can be provided with a line structuring. The line structuring can be pressed into the counterholder 40 and/or the non-slip element 42 to improve the clamping effect.

Preferably, even with closed clamping between the clamping element 34 and the counterholder 40, there can still be an open cross-section for air intake through a gap between the clamping element 34 and a surrounding portion of the shaft main body 22. Via this cross-section, a defined airflow can preferably be set. This can be used, for example, to cool the vacuum source. If necessary, this gap can be structurally adapted to the requirements of the respective vacuum source. For example, the further the clamping element 34 can be extended, the more open cross-section can be created during active clamping.

The tolerance compensation elements 48 can preferably be arranged on one or both end regions of the shaft main body 22. The tolerance compensation elements 48 can, for example, be formed to project, e.g. in the form of a raised plate or a nose or curved in shape. The tolerance compensation elements 48 can be arranged in a manner distributed around an outer circumference of the shaft main body 22. The tolerance compensation elements 48 can hold the shaft main body 22 in a form-fitting and optionally force-fitting manner in the jacket 16, if present.

The tape sensor 50 can preferably detect when a beginning of the label tape has been received in the longitudinal gap 24.

The tape sensor 50 can be connected to the shaft 14 in a rotationally fixed manner. Preferably, the tape sensor 50 can be arranged in the shaft 14.

The tape sensor 50 is for example an optical sensor, e.g. a laser sensor or an LED sensor. The tape sensor 50 can be for example a light barrier, e.g. a reflective light barrier. In this context, FIGS. 6 and 7 show, purely schematically, a signal beam (e.g. light or laser beam) S that the tape sensor 50 can emit in order to detect the beginning of the label tape.

For example, the tape sensor 50 can be arranged in a free end region of the shaft 14 and/or of the shaft main body 22. It can be sufficient to arrange the tape sensor 50 only in the free end region of the shaft 14, since label tapes with different heights can always be wound onto the shaft 14 in contact with and guided by the shoulder 18. When picked up by the shaft 14, the lower edge of the label tape will therefore always be located at the lower edge of the longitudinal gap 24, where the tape sensor 50 can also be located.

(E.g. electrical) signals from the tape sensor 50 can be conducted from the shaft 14 e.g. via a signal line 52. Preferably, a longitudinal axis of the signal line 52 can be parallel to and spaced apart from a central longitudinal axis of the shaft main body 22. For example, the shaft main body 22 can have a plurality of holding elements in its interior along its length. The holding elements can preferably hold the signal line 52 in a detachable manner (see e.g. FIG. 3). The holding elements can for example be designed as cable clips.

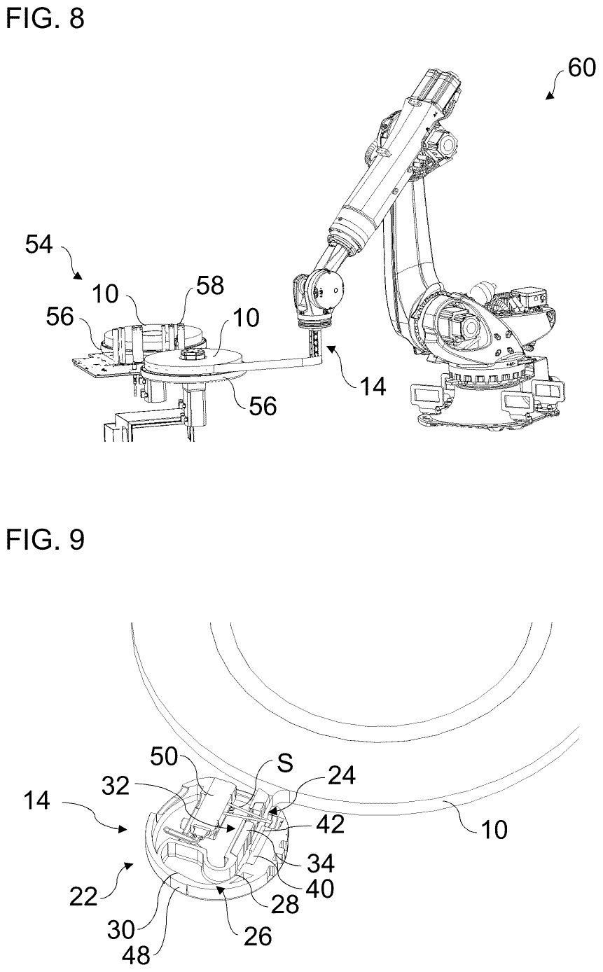

FIG. 8 shows a detail of a labeling system 54. The labeling system 54 can for example also include a labeling unit (not shown) for labeling containers. The labeling unit can label with a label from a label tape the containers transported by an (e.g. linear or rotary) container conveyor (also not shown in FIG. 8) as they pass the labeling unit.

Preferably, the labeling system 54 can have two or more label roll holders 56, each for holding a label roll 10 for feeding a label tape to the labeling unit. For example, the label roll holders 56 can be formed as turntables and/or can each have a rotatable clamping shaft for a label roll 10. Preferably, the rotary tables can be horizontally oriented and/or the clamping shafts can be vertically oriented. It is also possible for the label roll holders 56 to be formed as, preferably vertically oriented, compartments (e.g. slide-in units) of a label roll storage device.

Preferably, the labeling system 54 can further comprise an adhesive device 58 for gluing a beginning of a label tape from one of the label rolls 10 to an end of a label tape from the other label roll 10. Preferably, the adhesive device 58 can be designed as a so-called splicing device.

The labeling system 54 can further comprise a handling apparatus 60 with the shaft 14. The handling apparatus 60 is preferably a stationary handling apparatus. The handling apparatus 60 can preferably be a robotic handling apparatus, e.g. an articulated-arm robotic handling apparatus.

Preferably, the shaft 14 is an end effector of the handling apparatus 60. Preferably, the shaft 14 can only be rotatably mounted at one end of the shaft 14, namely opposite its free end.

A drive unit of the handling apparatus 60 can be connected to the shaft 14 in a driving manner for rotating the shaft 14 about a central longitudinal axis of the shaft 14. The drive unit is preferably an electric drive unit, e.g. a servo motor. Preferably, the drive unit can be connected to the shaft 14 via a gear mechanism. Alternatively, the drive unit can be directly connected to shaft 14. The drive unit can makes it possible for the shaft 14 to rotate in both directions.

With reference to FIGS. 8 and 9, a method for handling a label tape from a label roll 10 using the shaft 14 is explained below by way of example.

The beginning of a label tape from the label roll 10 is received in the longitudinal gap 24. For this purpose, the label roll 10 can for example be mounted on one of the label roll holders 56. Preferably, picking up the beginning of the label tape can be supported by sucking/sucking in the beginning into the longitudinal gap 24 using the suction device 26. Preferably, the beginning of the label tape can be received and, if necessary, sucked into the longitudinal gap 24 so far that it is positioned between the clamping element 34 and the counterholder 40 (and, if necessary, the non-slip element 42).

Preferably, the tape sensor 50 can detect that the beginning of the label tape has been received in the longitudinal gap 24. The tape sensor 50 can output a corresponding detection signal, e.g. to a processing unit of the handling apparatus 60.

For example, the clamping device 32 can be actuated by the processing device in response to receiving a signal output from the tape sensor 50. The beginning of the label tape which is received in the longitudinal gap 24 can be clamped by the clamping device 32. For example, the beginning of the label tape received in the longitudinal gap 24 can be clamped between the clamping element 34 and the counterholder 40 (and possibly the non-slip element 42). To actuate the clamping device 32 for moving the clamping element 34, compressed air can preferably be supplied to the at least one clamping actuator 36 (see e.g. FIG. 7).

The detachment of the portion from the label roll 10 is then preferably carried out by a shearing or pulling motion. This movement can be done for example by a (e.g. robot arm) movement of the handling apparatus 60.

After the beginning of the label tape has been received and preferably held in the longitudinal gap 24, a portion of the label tape can be wound (wrapped) onto the shaft 14. For this purpose, the shaft 14 can preferably be rotated about a central longitudinal axis of the shaft 14 by a drive unit of the handling device 60. Preferably, at least one full circumference of the label roll 10 is wound onto the shaft 14 as a portion of the label tape, e.g. due to contamination and adhesive tape residues, as well as for secure attachment to the shaft 14.

The label tape held on the shaft 14 can then be moved and handled as desired by the handling apparatus 60, by moving the shaft 14 in space to a desired destination. For example, the handling apparatus 60 can feed the label tape to the gluing device 58 for gluing to one end of the other label tape of the label roll 10 from the other label roll holder 56. Optionally, the label tape can be prepared beforehand, e.g. cut to size and/or equipped with an adhesive (e.g. adhesive tape), e.g. by the handling apparatus 60 or another apparatus.

It is possible that when the beginning of the tape is placed in the gluing device 96, a residual part of the label tape wound around the shaft 14 is cut off and remains on the shaft 14.

For example, this remaining part could be cut off by a cutting unit on shaft 14. Preferably only the part on shaft 14 that is in the clamp thus remains. The suction device 26 could be used to suck up and dispose of this remaining part. In this case, a partial non-stick coating inside the suction device 26 could ensure that the remaining part, to which adhesive can be applied, does not stick to the suction device 26 and clog it.

Alternatively, it is possible, for example, to move the wound-on remaining part to an external suction station. The suction station can, for example, include a stationary suction unit by which the remaining part could be sucked away. By rotating the shaft 14 and opening the clamping device 32, the remaining part could be detached from the shaft 14.

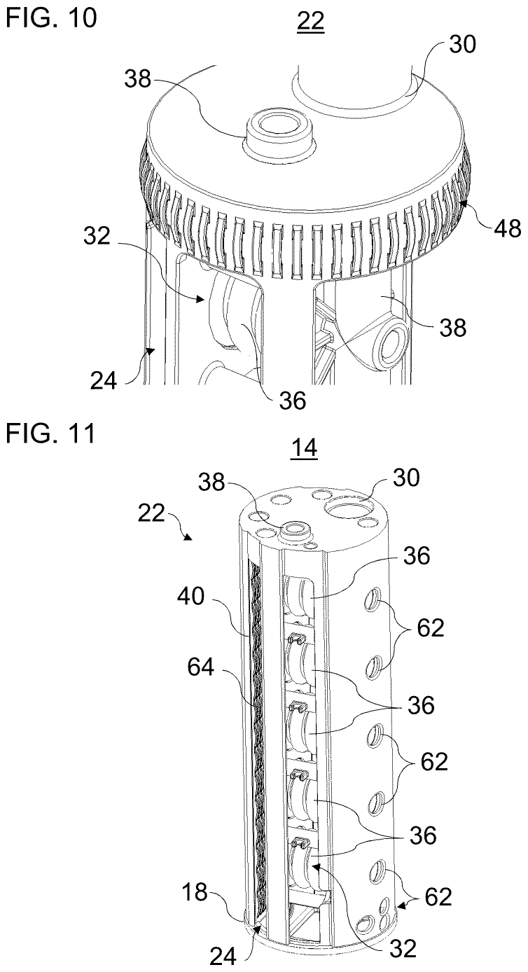

With reference to FIGS. 10 ff., different variants and modifications of the shaft 14 and the shaft main body 22 are explained below. It will be understood that all features can be combined with each other and with the features already explained, individually and in any combination.

FIG. 10 shows a modified shaft main body 22.

For example, the tolerance compensation elements 48 of the shaft main body 22 can be formed in a curved shape as tolerance compensation arcs. The arc-shaped tolerance compensation elements 48 can be arranged at one or both end regions of the shaft main body 22, distributed around an outer circumference of the shaft main body 22. Preferably, a plurality of curved tolerance compensation elements 48 are arranged in the manner of a collar on one or both end regions of the shaft main body 22.

FIG. 11 shows a modified shaft 14.

For example, the shaft 14 may not have a jacket. Instead, an outer circumferential face of the shaft main body 22 can itself form an outer circumferential face of the shaft 14. Accordingly, the outer circumferential face of the shaft 14, onto which the label tape is wound, can preferably be produced by additive manufacturing.

If, for example, PA12 is used as the production material, an advantageous property of the outer circumferential face of the shaft 14/the shaft main body 22 can be that it has non-stick properties for adhesives. This would prevent, for example, (double-sided) adhesive tape from sticking to the outer face.

Preferably, the outer circumferential face of the shaft 14 formed by the shaft main body 22 can have a plurality of depowdering openings 62. The depowdering openings 62 can, for example, be arranged spaced apart from one another along a longitudinal axis of the shaft 14/the shaft main body 22 in the outer circumferential face. Alternatively or additionally, the depowdering openings 62 can be arranged, for example, distributed around the outer circumferential face of the shaft 14/the shaft main body 22.

It is possible for the shaft main body 22 to have the counterholder 40. The counterholder 40 can be manufactured directly together with the rest of the shaft main body 22, e.g. having the suction device 26 and/or the clamping device 32, preferably additively manufactured. This means that additional manufacturing and assembly steps for the counterholder 40 can be dispensed with. This can advantageously reduce costs further.

As illustrated by way of example in FIG. 11, the counterholder 40 can, for example, have a flexible and/or rough structuring 64 in order to increase the coefficient of friction. The beginning of the label tape can then be clamped between the flexible and/or rough structuring 64 of the counterholder 40 and the clamping element 34 (hidden in FIG. 11) of the clamping device 32.

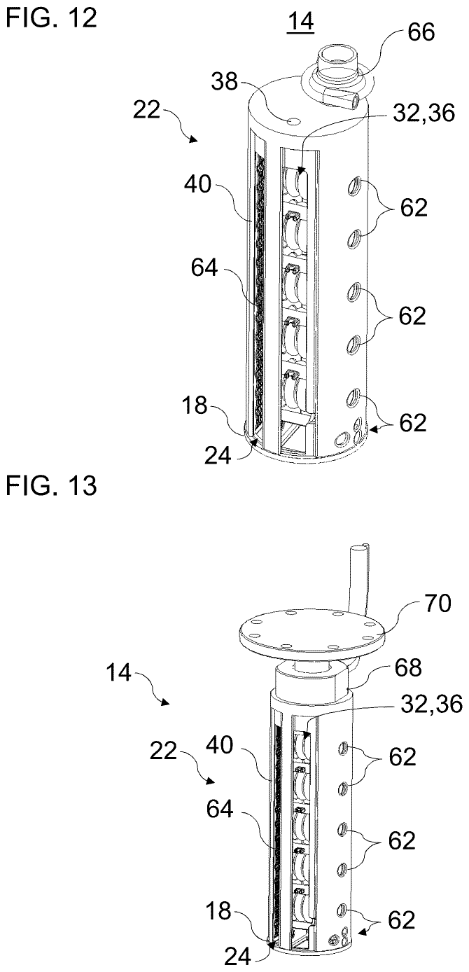

FIG. 12 shows a modified shaft 14.

Preferably the shaft 14 can have a vacuum generator 66 or be directly connected thereto. The vacuum generator 66 can, for example, be comprised as a region of the shaft main body 22 or can be integrally formed in one piece with the shaft main body 22. Preferably the vacuum generator 66 can be arranged at one end of the shaft 14, e.g. at the end face.

Preferably, the vacuum generator 66 can be formed from a plurality of adjacent, additively manufactured material layers. The material layers can be, for example, polyamide material layers (PA material layers), such as PA12. For example, the vacuum generator 66 can be additively manufactured using a powder bed method (e.g. MJF-Multi-Jet Fusion) or a PolyJet method (e.g. PolyJet Modeling).

For example, the vacuum generator 66 can be realized as a volume flow booster. The vacuum generator 66 can, for example, receive a relatively small airflow via a defined geometry (e.g. venturi nozzle) and generate an airflow that is larger relative thereto. This can advantageously eliminate the need for an external device to generate the vacuum.

FIG. 13 shows a modified shaft 14.

Preferably the shaft 14 can have a rotary distributor 68 and/or a mounting flange 70 or be directly connected thereto.

The rotary distributor 68 and/or the mounting flange 70 can, for example, be comprised as a portion of the shaft main body 22 or be integrally formed in one piece with the shaft main body 22.

Preferably the rotary distributor 68 and/or the mounting flange 70 can be arranged at one end of the shaft 14, e.g. at the end face.

Preferably, the rotary distributor 68 and/or the mounting flange 70 can be formed from a plurality of adjacent, additively manufactured material layers. The material layers can be, for example, polyamide material layers (PA material layers), such as PA12. For example, the rotary distributor 68 and/or the mounting flange 70 can be additively manufactured using a powder bed process (e.g. MJF: Multi-Jet Fusion) or a PolyJet method (e.g. PolyJet modeling).

The rotary distributor 68 can, for example, be designed to transmit a vacuum to the suction device 26 (hidden in FIG. 13) and/or compressed air to the clamping device 32. Preferably, the rotary distributor 68 can transmit the vacuum or compressed air independently of a rotational position of the shaft 14, e.g. at an angle of >360° (continuous rotation). For transmission, the rotary distributor 68 can for example have a stationary part, which can for example be connected to a mounting flange (e.g. mounting flange 70) in a rotationally fixed manner, and a rotatable part, which can for example be connected to the shaft main body 22/the shaft 14 in a rotationally fixed manner.

The mounting flange 70 can, for example, be formed to mount the shaft 14 to a receptacle (e.g. robot arm) of the handling apparatus 60 (see FIG. 8). The mounting flange 70 can thus for example make it possible to connect the shaft 14 to the handling apparatus 60.

It is possible, for example, that in places where the manufacturing accuracy of the mounting flange 70 is inadequate, e.g. due to process limitations of the additive manufacturing method, the mounting flange 70 is post-processed by machining.

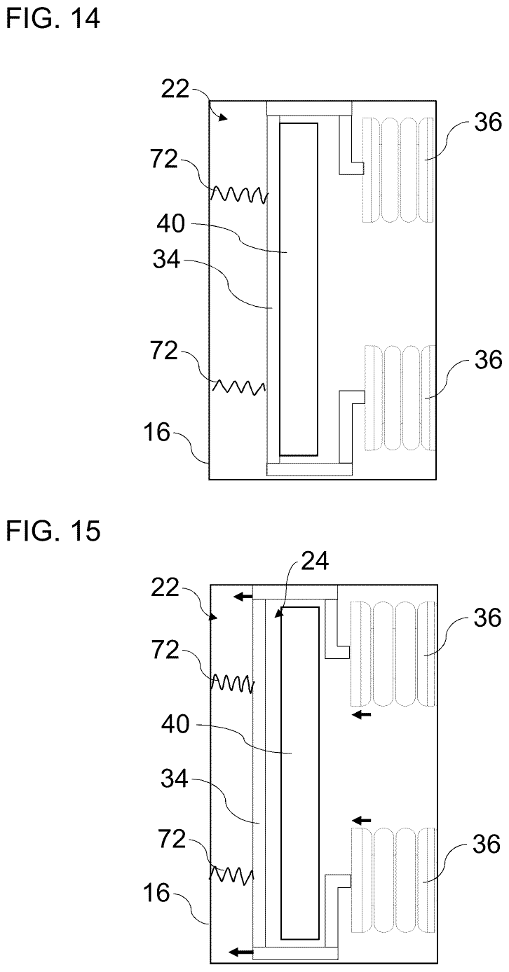

FIGS. 14 to 17 show different variants in which a clamping function of the shaft 14 is elastically pre-tensioned, preferably pre-tensioned by a spring force.

The shaft 14 can have at least one elastic element 72. Preferably, a plurality of elastic elements 72 are included. The elastic elements 72 can, for example, be spaced apart from each other relative to a longitudinal axis of the shaft 14.

Preferably, the at least one elastic element 72 can be formed as a spring element, e.g. a compression spring element or tension spring element.

For example, the at least one elastic element 72 can elastically pre-tension the clamping element 34 for clamping, i.e. for moving it towards the counterholder 40. To open the clamping, for example the at least one clamping actuator 36 can be actuated, e.g. by application of compressed air. The actuated at least one clamping actuator 36 can move the clamping element 34 away from the counterholder 40 against the elastic pre-tensioning. This advantageously ensures that the beginning of the label tape remains securely held, even in the event of e.g. a compressed air failure.

The at least one elastic element 72 can for example be supported on the shaft main body 22 and/or on the jacket 16.

The at least one elastic element 72 can be arranged e.g. as a conventional clamping element in the shaft main body 22 during assembly of the shaft 14 for pre-tensioning the clamping element 34.

Alternatively, the at least one elastic element 72 can be formed, for example, from a plurality of adjacent, additively manufactured material layers. For example, the at least one elastic element 72 can be a region of the shaft main body 22 and can thus be manufactured directly during the additive manufacturing thereof.

FIGS. 14 and 15 show in detail how a plurality of elastic elements 72 elastically pre-tension the clamping element 34 towards the counterholder 40 for clamping. The elastic elements 72 are preferably conventional tension or compression springs.

By actuating the clamping actuators 36, the clamping between the clamping element 34 and the counterholder 40 can be released, as shown in FIG. 15. The actuated clamping actuators 36 can move the clamping element 34 away from the counterholder 40 against the pre-tensioning force exerted by the elastic elements 72.

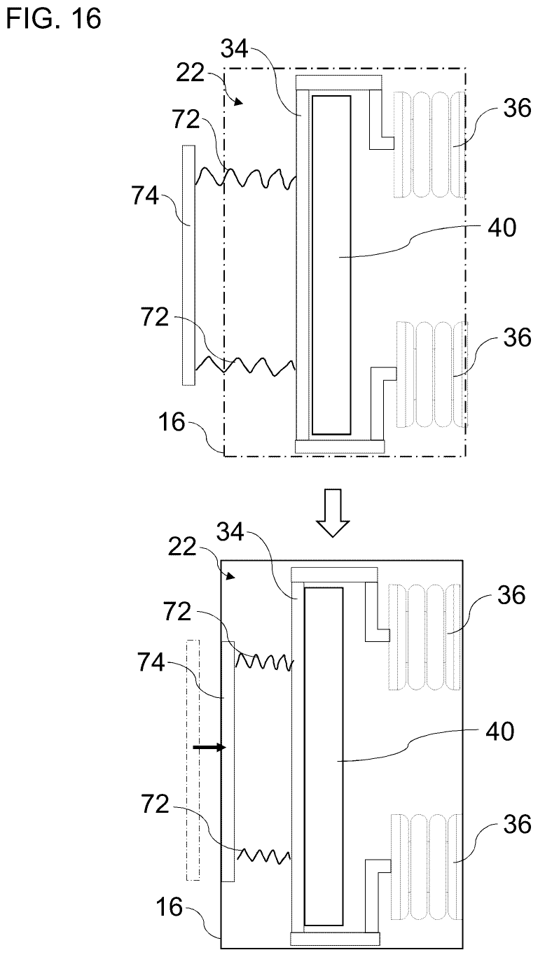

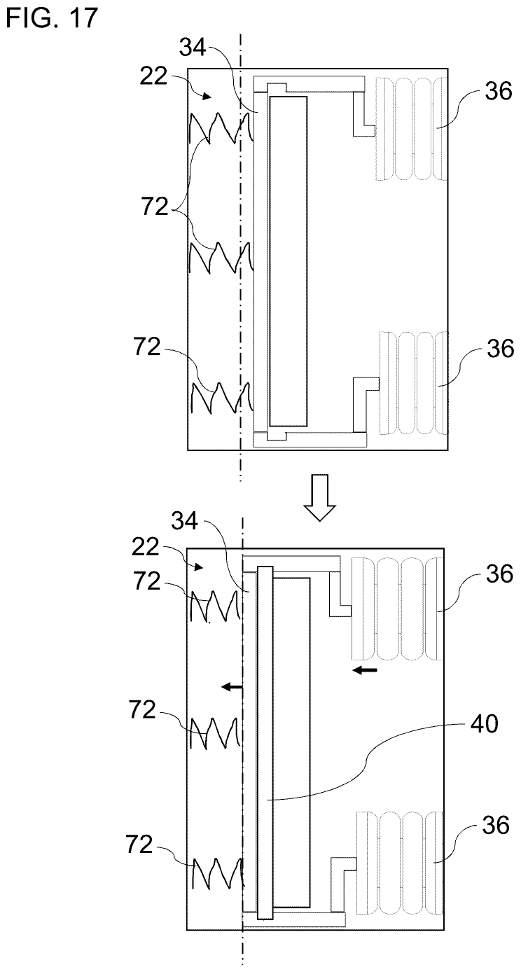

FIGS. 16 and 17 show how an embodiment with at least one additively manufactured elastic element 72 can be realized.

The at least one elastic element 72 can initially be manufactured in a relaxed state during additive manufacturing, e.g. as a region of the shaft main body 22. The elastic pre-tensioning is then applied subsequently during assembly, e.g. when inserting the shaft main body 22 into the jacket 16 (see FIG. 16) or when inserting the counterholder 40 into the shaft main body 22 (see FIG. 17).

The upper illustration in FIG. 16 shows that the at least one elastic element 72 can be additively manufactured in such a way that one end of the at least one elastic element 72 in the relaxed state would project beyond the jacket 16. The other end of the at least one elastic element 72 can, for example, be directly connected to the clamping element 34. If a plurality of elastic elements 72 are included, the one end of the elastic elements 72 can be connected to each other, for example via a connecting element 74.

The lower illustration in FIG. 16 shows how, by insertion of the shaft main body 22 into the jacket 16, the at least one elastic element 72 is compressed and thus pre-tensioned. The one end of the at least one elastic element 72 or of the connecting element 74, if present, can be supported on an inner circumferential face of the jacket 16. For example, the elastic pre-tensioning can overcome or eliminate any gap that may still exist between the clamping element 34 and the counterholder 40 in the unmounted state.

The upper illustration in FIG. 17 shows that the clamping element 34, in the relaxed state of the at least one elastic element 72, is separated from an opposite counterface by a (minimal) gap. This can, for example, prevent fusion with the counterface during the additive manufacturing process.

The lower illustration in FIG. 17 shows that during shaft mounting, the counterholder 40 can be inserted into the shaft main body 22. As already mentioned, the counterholder 40 can, for example, itself be additively manufactured separately and/or can carry a non-slip element. The counterholder 40 inserted into the shaft main body 22 can press the clamping element 34 against the at least one elastic element 72. The at least one elastic element 72 can thereby be compressed and the clamping element 34 elastically pre-tensioned against the counterholder 40. It is possible for the at least one clamping actuator 36 to be stretched by the displacement path of the clamping element 34.

This variant can be useful for example if there is no separate jacket 16, and instead the shaft main body 22 itself forms an outer circumferential face of the shaft 14.

The invention is not limited to the preferred exemplary embodiments described above. Rather, a plurality of variants and modifications are possible which likewise make use of the inventive concept and therefore fall within the scope of protection. In particular, the invention also claims protection for the subject matter and the features of the dependent claims, irrespective of the claims to which they refer. In particular, the individual features of independent claim 1 are each disclosed independently of one another. In addition, the features of the dependent claims are also disclosed and claimable independently of all features of independent claim 1 and, for example, independently of the features relating to the presence and/or the configuration of the shaft main body and/or of the longitudinal gap of independent claim 1. All ranges specified herein are to be understood as disclosed and claimable in such a way that all values falling within the relevant range are individually disclosed, e.g., also as the relevant preferred narrower outer limits of the relevant range.

List of Reference Signs

| | |
|---|---|
| 10 | label roll |
| 12 | adhesive tape |
| 14 | shaft |
| 16 | jacket |
| 18 | shoulder |
| 20 | longitudinal gap |
| 22 | shaft main body |
| 24 | longitudinal gap |
| 26 | suction unit |
| 28 | suction nozzle |
| 30 | vacuum line |
| 32 | clamping device |
| 34 | clamping element |
| 36 | clamping actuator |
| 38 | compressed air line |
| 40 | counterholder |
| 42 | anti-slip element |
| 44 | dovetail guide |
| 46 | latching connection |
| 48 | tolerance compensation element |
| 50 | tape sensor |
| 52 | signal line |
| 54 | labeling system |
| 56 | label roll holder |
| 58 | gluing device |
| 60 | handling apparatus |
| 62 | depowdering opening |
| 64 | structuring |
| 66 | vacuum generator |
| 68 | rotary distributor |
| 70 | mounting flange |
| 72 | elastic element |
| 74 | connecting element |
| S | signal beam |

1. A shaft for winding on a portion of a label tape from a label roll for a handling apparatus for handling the label tape of the label roll, wherein the shaft comprises:
a shaft main body with a longitudinal gap for receiving and holding a beginning of the portion of the label tape.

2. The shaft according to claim 1, wherein:
the shaft main body is formed from a plurality of adjacent material layers.

3. The shaft according to claim 1, wherein at least one of the following is met:
the shaft main body has an essentially cylindrical outer shape;
the longitudinal gap opens in an outer circumferential face of the shaft main body;
the shaft is a hollow shaft;
an outer circumferential face of the shaft has a non-stick coating;
the shaft has a circumferential shoulder at its free end to prevent the label tape from slipping off the shaft;
the longitudinal gap extends substantially along an entire length of the shaft main body;
the shaft and the shaft main body has at least one of a total length≥200 mm and ≤300 mm; and
at least one of the shaft and the shaft main body has an outer diameter≥50 mm and ≤100 mm.

4. The shaft according to claim 1, further comprising:
a jacket which surrounds the shaft main body.

5. The shaft according to claim 1, wherein:
the shaft main body has a suction device for sucking the beginning of the portion of the label tape into the longitudinal gap.

6. The shaft according to claim 5, wherein at least one of the following conditions is met:
the suction device is arranged in the shaft;
the suction device has a suction nozzle which is connected to the longitudinal gap for sucking in the beginning of the portion of the label tape;
the suction device is formed from a plurality of adjacent material layers;
the suction device is formed from a plurality of adjacent. additively manufactured material lavers:
the suction device extends substantially along an entire length of the shaft main body; and
the suction device has a vacuum line which is arranged parallel and spaced apart from a central longitudinal axis of the shaft.

7. The shaft according to claim 1, wherein:
the shaft main body has a, preferably pneumatic, clamping device which is arranged to clamp the beginning of the portion of the label tape in the longitudinal gap.

8. The shaft according to claim 7, wherein at least one of the following is met:
the clamping device is a pneumatic clamping device;
the clamping device is arranged in the shaft;
the clamping device is formed from a plurality of adjacent material layers;
the clamping device is formed from a plurality of adjacent, additively manufactured material lavers;
the clamping device has a clamping element which is movable for clamping and releasing the beginning of the portion of the label tape;
the clamping device has a elastically pre-tensioned clamping element which is movable for clamping and releasing the beginning of the portion of the label tape;
the shaft main body has a counterholder or a counterholder of the shaft is detachably positioned in the shaft main body, wherein the counterholder is arranged to clamp the beginning of the portion of the label tape between itself and the clamping device; and
the shaft main body has a counterholder or a counterholder of the shaft is detachably positioned in the shaft main body via at least one of a dovetail guide and a latching connection, wherein the counterholder is arranged to clamp the beginning of the portion of the label tape between itself and the clamping device.

9. The shaft according to claim 7, wherein:
the clamping device has at least one clamping actuator for moving a clamping element of the clamping device.

10. The shaft according to claim 1, further comprising:
a tape sensor arranged to detect the beginning of the label tape portion received in the longitudinal gap.

11. The shaft according to claim 10, wherein at least one of the following is met:
the tape sensor is arranged in the shaft main body;
the tape sensor is an optical sensor;
the tape sensor is connected to the shaft main body in a rotationally fixed manner;
the tape sensor is arranged in or on a free end region of the shaft; and
the shaft main body has a plurality of holding elements in its interior along its length that hold a signal line that is connected to the tape sensor.

12. A handling apparatus for handling a label tape of a label roll, wherein the handling apparatus comprises:
a shaft according to claim 1,
wherein preferably at least one of the following is met:
the shaft is an end effector of the handling apparatus;
the shaft is rotatably mounted only at one end of the shaft; and
at least one of a rotary distributor, a mounting flange and a vacuum generator is formed from a plurality of adjacent material layers, preferably together with the shaft main body.

13. A method for handling a label tape of a label roll by means of a shaft according to claim 1 or by means of a handling apparatus, wherein the method comprises:
picking up the beginning of a portion of a label tape from a label roll in the longitudinal gap of the shaft main body.

14. A method for manufacturing a shaft according to claim 1, wherein the method comprises:
additive manufacturing of the shaft main body of the shaft in a plurality of adjacent material layers.

15. A computer program product having instructions causing an additive manufacturing apparatus to:
manufacture a shaft according to one of claim 1 in a plurality of material layers in an additive manufacturing method.

16. The shaft according to claim 1, wherein at least one of:
the shaft is a suction shaft;
the shaft is a clamping shaft;
the longitudinal gap is a longitudinal suction gap;
the longitudinal gap is a longitudinal clamping gap; and
the shaft main body is formed from a plurality of adjacent, additively manufactured material layers.

17. The shaft according to claim 4, wherein at least one of:
the jacket is a sleeve-shaped jacket;
the jacket is a metallic jacket;
the jacket comprises a non-stick coating on its outer circumferential face;
one or both end regions of the shaft main body has or have, projecting or nose-shaped or arc-shaped, tolerance compensation elements which:
are distributed around an outer circumference of the shaft main body; and
hold the shaft main body in the jacket in a form-fitting and force-fitting manner.

18. The shaft according to claim 9, wherein at least one of:
the clamping device has at least one pneumatic, clamping actuator comprising a bellows, for moving the clamping element of the clamping device;
the at least one clamping actuator is formed from a plurality of adjacent, additively manufactured material layers; and
the shaft main body has a compressed air line which is connected to the at least one clamping actuator and is arranged parallel to a central longitudinal axis of the shaft.

19. The shaft according to claim 11, wherein at least one of the following is met:
the tape sensor is arranged in the shaft main body, for detecting the beginning of the portion of the label tape projecting into the shaft main body through the longitudinal gap;
the tape sensor is a laser sensor or an LED sensor;
the tape sensor is connected to the shaft main body in a rotationally fixed manner;
the tape sensor is arranged in or on a free end region of the shaft; and
the shaft main body has a plurality of holding elements in its interior along its length that hold a signal line that is connected to the tape sensor.

20. The method of claim 13 further comprising at least one of the following steps:
supporting the picking-up the beginning by suctioning of the beginning by means of a suction device of the shaft;
detecting of the beginning received in the longitudinal gap by means of a tape sensor of the shaft;
